(19) United States
(12) Patent Application Publication
(10) Pub. No.: US 2008/0270586 A1
(43) Pub. Date: Oct. 30, 2008

(54) ASSOCIATION TO COMMUNITIES

(75) Inventors: Todd Sampson, Orlando, FL (US); John Sampson, Orlando, FL (US); Steve Ho, Apopka, FL (US); Eric Marcoullier, San Francisco, CA (US); Neil Scott Rafer, San Francisco, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/742,361

(22) Filed: Apr. 30, 2007

(51) Int. Cl. G06F 15/173

(52) U.S. Cl. 709/223

(57) ABSTRACT

A system and method are directed towards managing affiliation to community sites and making such affiliations visible to visitors to the community sites, and/or a member's affiliation site. A visitor may register centrally to a plurality of community sites, and receive a member affiliation webpage. The member affiliation webpage may display community sites that the registered visitor may author, and/or community sites for which the registered visitor is affiliated. A visitor may also visit an affiliation webpage(s) for a community site that may display each visitor that is currently affiliated with that community site. By displaying members of the community site, other visitors might be able to quickly identify more interesting community sites, community sites popular to one of their friends, neighbors, family members, or the like. When a registered visitor visits a community site they may select to become affiliated or may become automatically affiliated based on a criteria.

### TECHNICAL FIELD

The present invention relates generally to social networking and, more particularly, but not exclusively to enabling visitors to self-affiliate themselves to various social networking community sites, and to provide visibility of such self-affiliations to other visitors.

### BACKGROUND

Tremendous changes have been occurring in the Internet that influence our everyday lives. For example, online social networks have become the new meeting grounds. They have been called the new power lunch tables and new golf courses for business life in the U.S. Moreover, many people are using such online social networks to reconnect themselves to their friends, their neighborhood, their community, and the world.

The development of such online social networks touch countless aspects of our everyday lives, providing instant access to people of similar mindsets, and enabling us to form partnerships with more people in more ways than ever before. For example, an increasing number of people are creating and/or visiting network blogs (or web logs). Briefly, a blog is a social networking website where a user may provide commentaries, news, graphics, videos, or the like, in a journal style. Such entries may be on virtually any subject, including food, politics, movies, movie stars, videos, music, gambling, shopping, politics, or even personal online diaries.

With bloggers (blog authors) talking amongst each other on their blog sites, many may wonder who is actually reading or even have read the blogs. Traditionally, a visitor to a blog may select to register to receive information from the blog, or other website, via email, RSS feeds, or the like. However, such actions may not readily reveal to others who is receiving the information, or is otherwise a current member of the website. Moreover, there is currently no convenient mechanism to let others know of which other websites a particular visitor is a member. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a network device useable for managing community affiliations;

FIG. 3 illustrates a logical flow diagram generally showing one embodiment of a process for centralized registration for community sites;

FIG. 4 illustrates a logical flow diagram generally showing one embodiment of a process for affiliating a registered visitor to a community site;

FIG. 5 illustrates a logical flow diagram generally showing one embodiment of a process for displaying a member's affiliations to various community sites;

FIG. 6 illustrates one embodiment of an example display of a member's affiliation webpage; and

FIG. 7 illustrates one embodiment of an example display of a community's affiliation webpage, in accordance with the present invention.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “social network” and “social community” refer to a concept that an individual's personal network of friends, family colleagues, coworkers, and the subsequent connections within those networks, can be utilized to find more relevant connections for a variety of activities, including, but not limited to dating, job networking, service referrals, content sharing, like-minded individuals, activity partners, or the like.

An online social network typically comprises a person's set of direct and/or indirect personal relationships, including real and virtual privileges and permissions that users may associate with these people. Direct personal relationships usually include relationships with people the user can communicate with directly, including family members, friends, colleagues, coworkers, and other people with whom the person has had some form of direct contact, such as contact in person, by telephone, by email, by instant message, by letter, or the like. These direct personal relationships are sometimes referred to as first-degree relationships. First-degree relationships can have varying degrees of closeness, trust, and other characteristics.

Indirect personal relationships typically include relationships through first-degree relationships to people with whom a person has not had some form of direct or limited direct contact, such as in being cc'd on an e-mail message, or the like. For example, a friend of a friend represents an indirect personal relationship. A more extended, indirect relationship might be a friend of a friend of a friend. These indirect relationships are sometimes characterized by a degree of separation between the people. For instance, a friend of a friend can be characterized as two degrees of separation or a second-degree relationship. Similarly, a friend of a friend of a friend can be characterized as three degrees of separation or a third-degree relationship.

The term “community site,” refers to a one or more of the plurality of social networking sites. Such community sites may be a blog site, a website, a photo's website, or similar website, typically useable for social networking activities.

The terms “distributed networking sites,” of “distributed community sites” refer a plurality of networking sites, or similar networking sites, that are configured and arranged to receive visitor information distributed from a centralized data source. In a typical example, a plurality of sites may register to receive such visitor information. At least one of the plurality of networking sites is managed distinct from another one of the plurality.

The term “affiliation” refers to an association of a user, visitor, or the like, with a community site as a member of the community site. Thus, to become affiliated with a community site is to join that community site as a member.

The following briefly describes the invention in order to provide a basic understanding of some aspects of the invention. This brief description is not intended as an extensive overview. It is not intended to identify key or critical elements, or to delineate or otherwise narrow the scope of the invention. Its purpose is merely to present some concepts in a simplified form as a prelude to the more detailed description that is presented later.

Briefly stated the present invention is directed towards managing affiliation to community sites and enabling such affiliations to be visible to visitors to the community sites, and/or a member's affiliation site. A visitor may register centrally to a plurality of community sites and receive a unique identifier that may be employed by the community sites to identifier the visitor. Such central registration typically does not include becoming affiliated to one or more of the distributed community sites. However, in one embodiment, the registering visitor may select one or more community sites with which to become affiliated during registration.

In one embodiment, during registration or even subsequent to registration, the visitor also may provide auto-affiliation criteria. For example, the visitor may indicate that the visitor is to be automatically affiliated to a community site when the visitor visits the community site a pre-determined number of times, accesses a pre-determined number of webpages within the community site, provides feedback to the community site, or the like.

In one embodiment, central registration provides the visitor with a member affiliation webpage. Displayed within the member affiliation webpage may be any community sites that the registered visitor may author or otherwise manage, as well as information about any community sites for which the registered visitor is affiliated. By displaying the registered visitor's affiliations, other visitors, friends, family, or the like, will be able to see which communities the registered visitor is affiliated. Then, in part, based one such affiliations, they may also select to become affiliated with at least one of the same community sites.

When the visitor visits one of the community sites, the visitor may become automatically registered if the auto-affiliation criteria are satisfied. In one embodiment, the visitor may also actively select an icon, or the like, to become affiliated to a particular community site, or even become un-affiliated with the particular community site if the visitor is currently affiliated.

The visitor may also visit an affiliation webpage(s) for a community site. Displayed within the community affiliation webpage(s) may be information about each visitor that is currently affiliated with that community site, visitors most recently having become affiliated, or the like. By displaying members of the community site, other visitors might be able to quickly identify more interesting community sites, community sites popular to one of their friends, neighbors, family members, or the like.

### Illustrative Operating Environment

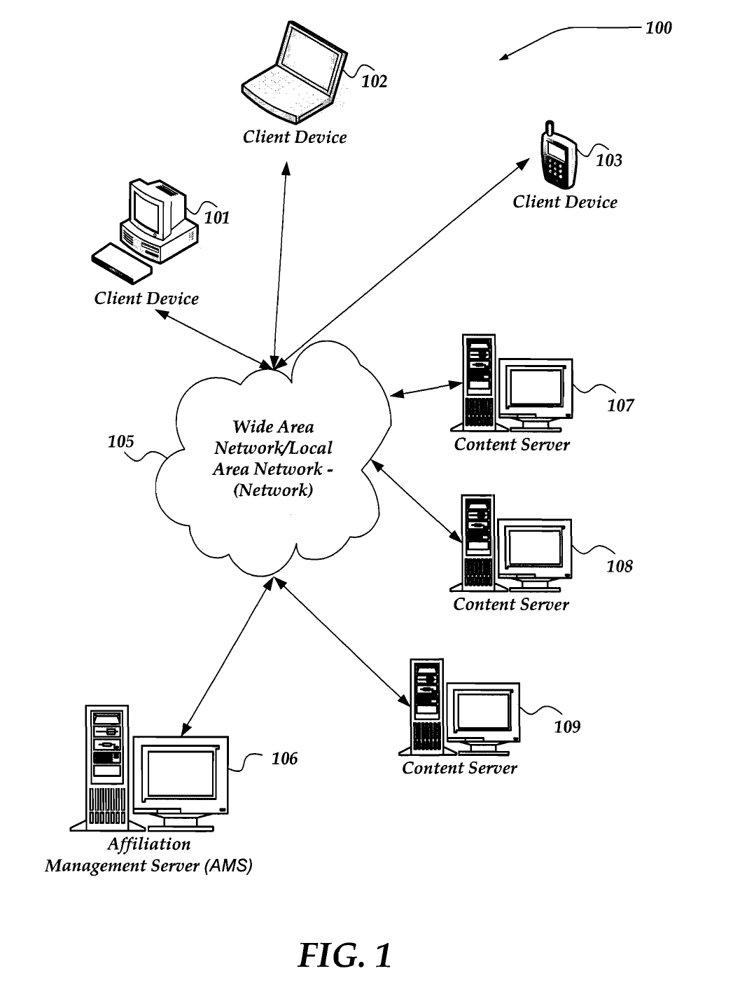

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)-(network) 105, Affiliation Management Server (AMS) 106, client devices 101-103, and content servers 107-109.

Generally, client devices 101-103 may include virtually any computing device capable of connecting to another computing device to send and receive information, including web requests for information from a server, providing content, or the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, radio frequency (RF) devices, infrared (IR) devices, integrated devices combining one or more of the preceding devices, or virtually any network device. Similarly, client devices 101-103 may be any device that is capable of connecting using a wired or wireless communication medium such as a PDA, POCKET PC, wearable computer, and any other device that is equipped to communicate over a wired and/or wireless communication medium.

Client devices 101-103 may include a client application that may be configured to provide information that identifies itself, including a type, capability, name, and the like. Client devices 101-103 may identify themselves through any of a variety of mechanisms, including a phone number, Mobile Identification Number (MIN), an electronic serial number (ESN), or a network address, such as an Internet Protocol (IP) address, or other network address identifier. In one embodiment, client devices 101-103 may be configured to provide such network address identifier in a message, or the like, sent over network 105 to another computing device. In one embodiment, at least some information about the client device may also be provided to another computing device, through a network cookie.

Client devices 101-103 may further include a client application that is configured to manage various actions. For example, client devices 101-103 may include a web browser application that is configured to enable an end-user to interact with other devices and/or applications over network 105. For example, client devices 101-103 may enable use of the web browser to access content, webpages, or the like, from another computing device, such as content servers 107-109, or the like. In one embodiment, client devices 101-103 may receive a network cookie from and/or provide the network cookie to content servers 106-109, and/or AMS 106.

In addition, client devices 101-103 may employ a variety of other client applications to communicate with other devices over network 105, including, but not limited to Voice Over Internet Protocol (VOIP), Instant Messaging (IM), Short Message Service (SMS), Multimedia Message Service (MMS), email, or the like. Thus, client devices 101-103 may employ a variety of mechanisms to establish network sessions with another computing device.

Network 105 is configured to couple one computing device with another computing device to enable them to communication information. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANS, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between one computing device and another computing device.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Content servers 107-109, may be configured to operate as website servers. However, content servers 107-109 are not limited to web servers, and may also operate a messaging server, a File Transfer Protocol (FTP) server, a database server, content server, and the like. Additionally, each of content servers 107-109 may be configured to perform a different operation. Thus, for example, content server 107 may be configured as a blog website, while content server 108 may be configured as music or video download server. Moreover, while content servers 107-109 may operate as other than a website, they may still be enabled to receive an HTTP communication. In one embodiment, content servers 107-109 may each operate a blog site, or other community site. In any event, content servers 107-109 collectively represent one embodiment of distributed community sites. It should be noted that more or less content servers may be included, and thus, the invention is not limited to the number or arrangement as illustrated.

In one embodiment, content servers 107-109 may be configured to provide visitor information using, for example, information associated with whether the visitor is affiliated with a community site hosted on the content server. However, in another embodiment, AMS 106 may be configured to display affiliation information for a community site hosted by one or more of content servers 107-109. Content servers 107-109 may also monitor information about the visitor's actions, including whether the visitor performs an action that may satisfy a visitor's defined auto-affiliation criteria. In one embodiment, content servers 107-109 may provide the visitor with a cookie that may be employed to track actions of the visitor. In one embodiment, content servers 107-109 may receive an identifier indicating that the visitor is centrally registered. If the visitor is unregistered, content servers 107-109 may be configured to display a screen, menu, link, or the like, to enable the visitor to centrally register. In one embodiment, when a visitor selects to centrally register, content servers 107-109 might redirect the visitor to AMS 106. Once centrally registered, each content server that subscribes to AMS 106's services may access, employ, and/or selectively display visitor information.

Devices that may operate as content servers 107-109 include personal computers desktop computers, multiprocessor systems, microprocessor-based or programmable consumer electronics, network PCs, servers, and the like.

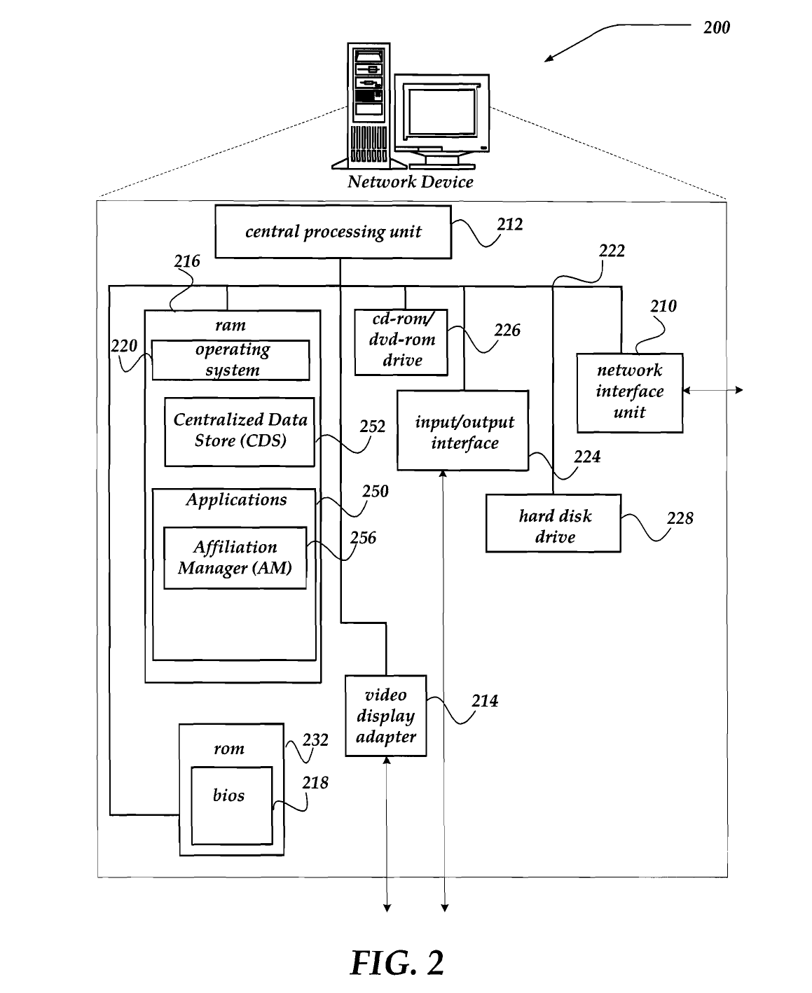

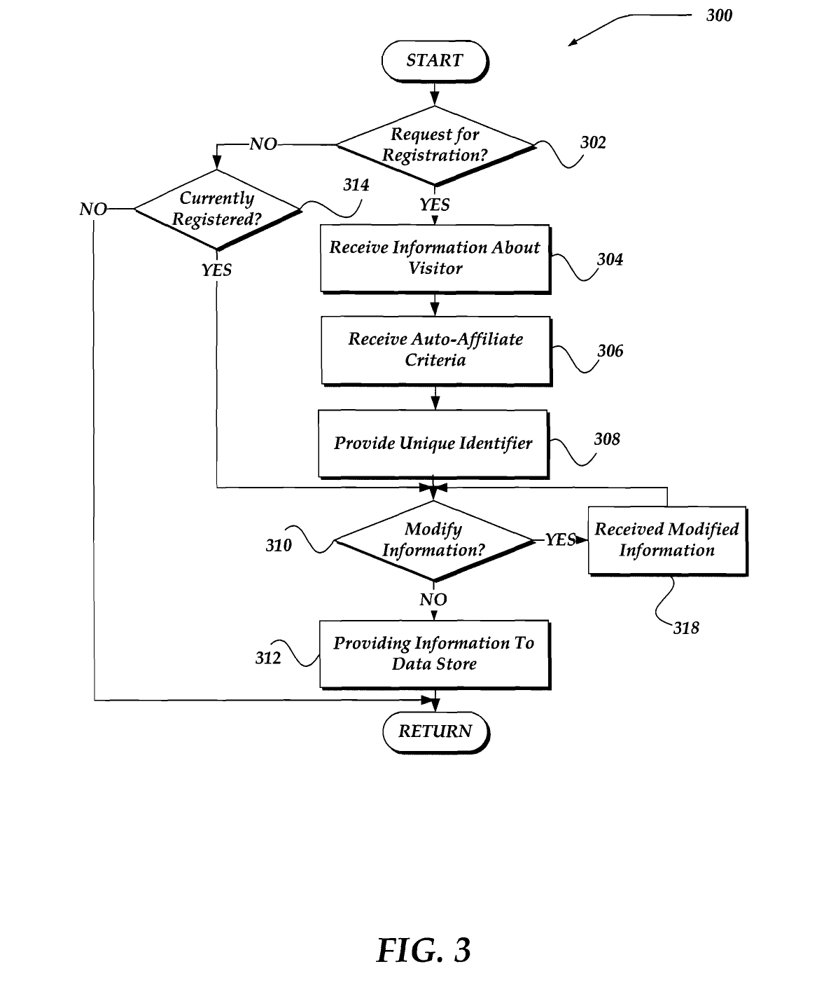

One embodiment of AMS 106 is described in more detail below in conjunction with FIG. 2. Briefly, however, AMS 106 may include any computing device capable of connecting to network 105 to enable a visitor to a social networking website, or virtually any other website, to centrally register for display and/or use of their information at the website. Moreover, in one embodiment, AMS 106 may enable the registering visitor to define at least one auto-affiliation criteria, useable in determining when, if at all, to automatically affiliate the registered visitor to a community site. In one embodiment, AMS 106 may perform at least some of its actions for registrations using a process such as described below in conjunction with FIG. 3.

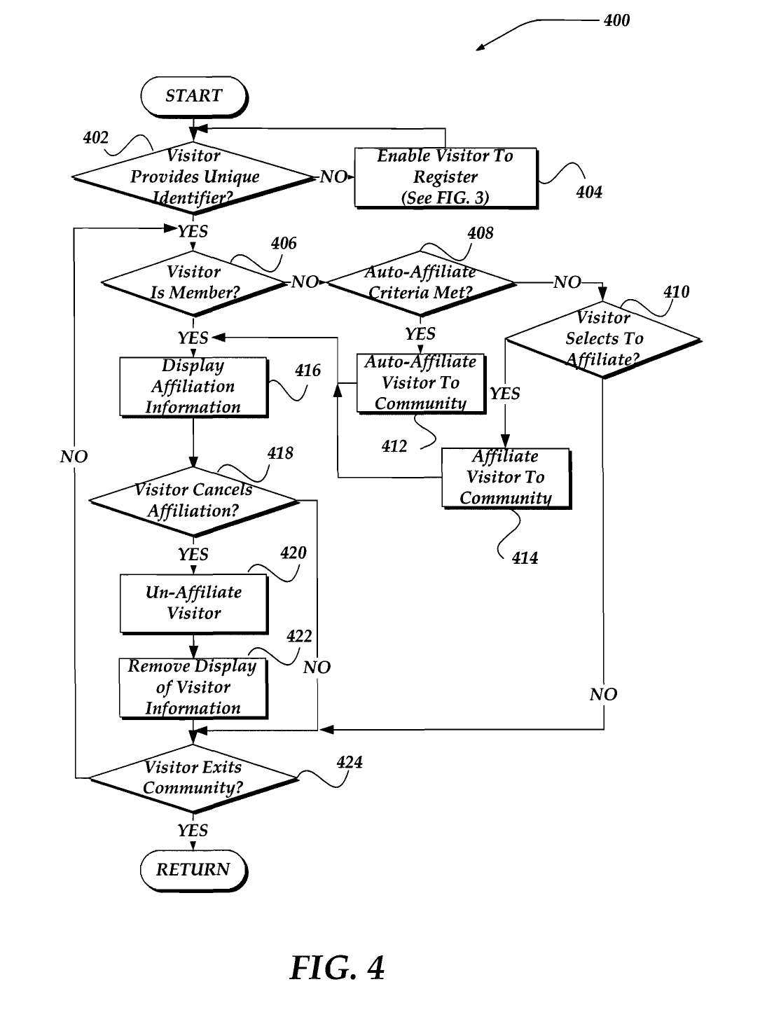

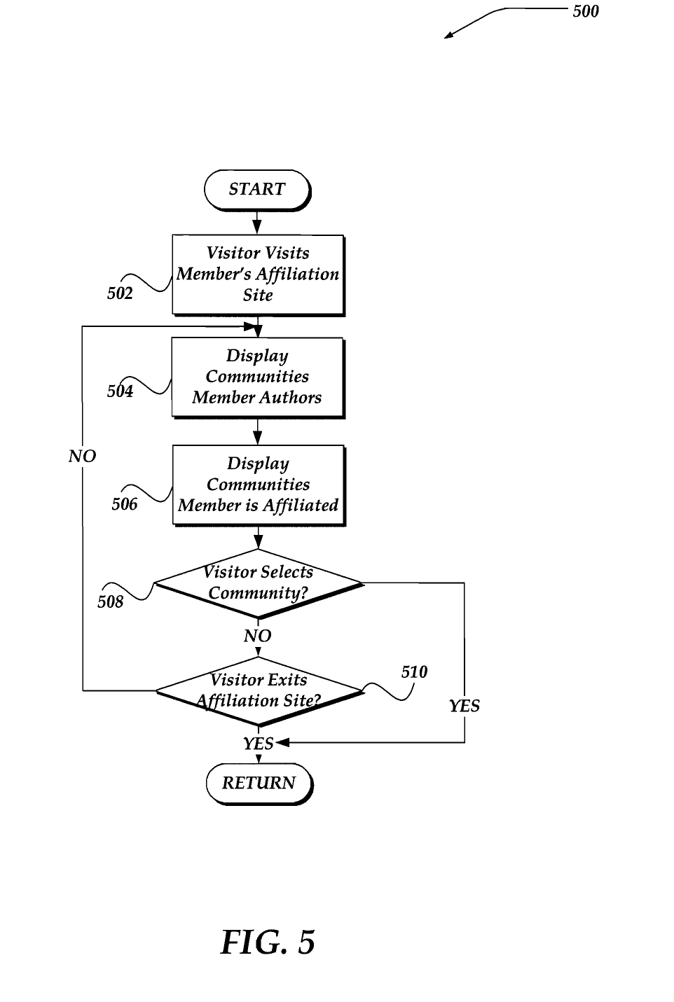

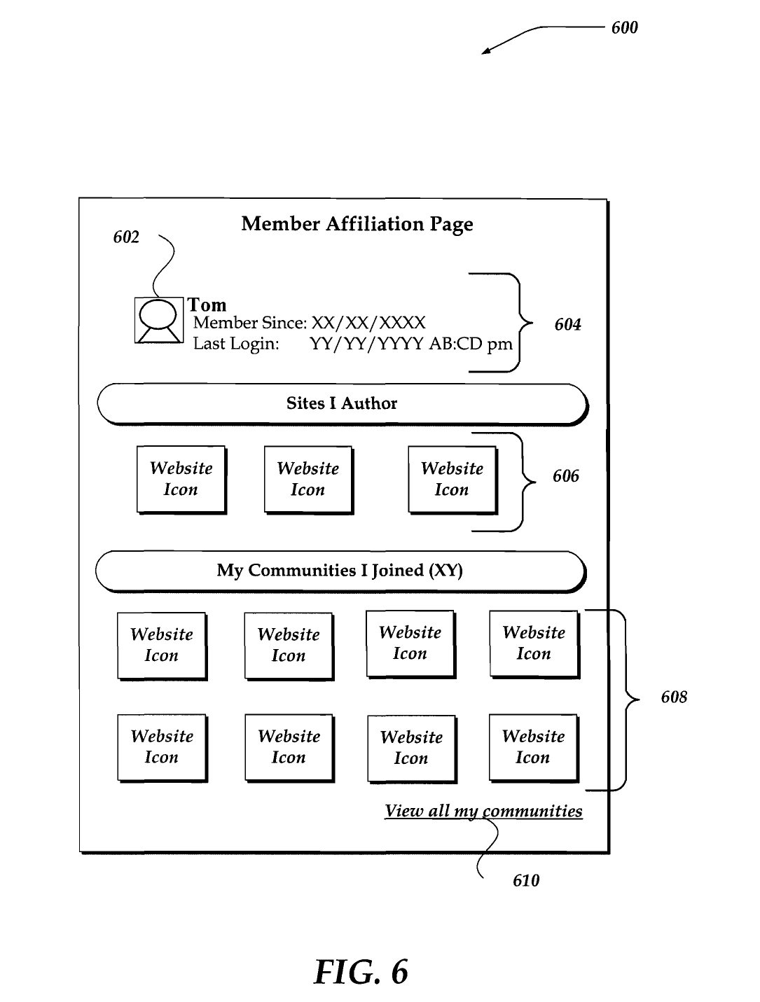

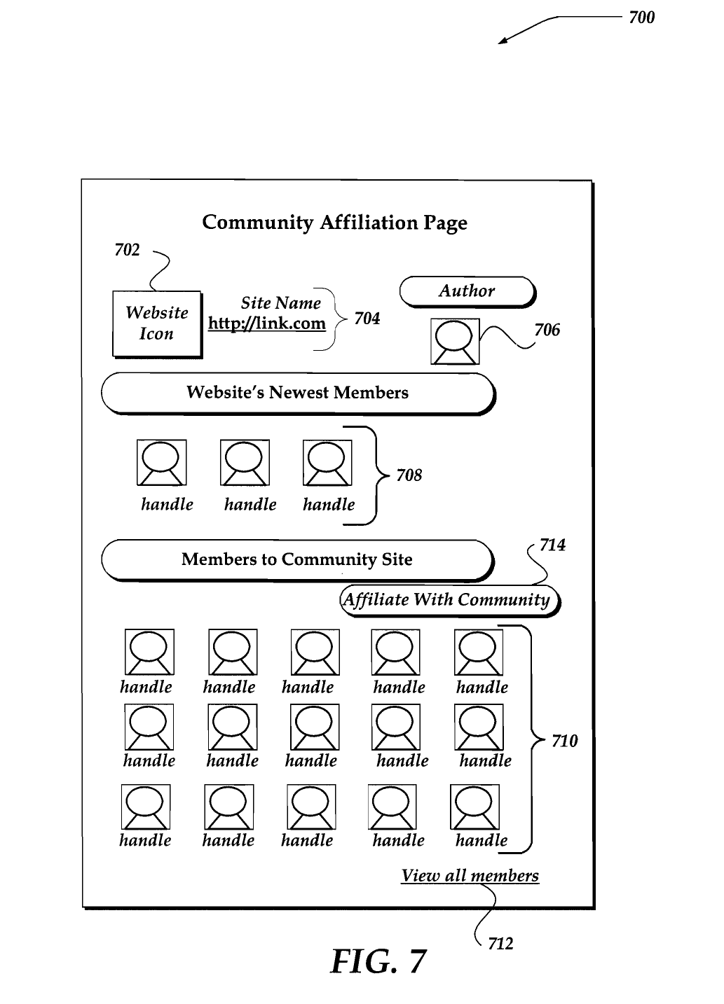

AMS 106 may also be configured and arranged to provide visibility of affiliations to various community sites. AMS 106 may display, in one embodiment, such community site affiliations using a screen display such as described below in conjunction with FIG. 7. In addition, AMS 106 may be further configured and arranged to provide visibility of a registered visitor's affiliations to various communities. One embodiment of a screen display that illustrated such visitor affiliations is described below in conjunction with FIG. 6. In one embodiment, AMS 106 may employ processes such as described below in conjunction with FIGS. 4-5 for use in displaying, and/or affiliating a registered visitor.

AMS 106 may enable registration by a visitor, and manage a centralized data store for use by content servers 107-109, or other distributed community sites. In one embodiment, AMS 106 may provide a menu interface, a forms interface, window, or the like, to enable a visitor to enter personal information, including, but not limited to profile information such as a photograph, name, alias, address or the like; contact information, including, for example, email address, phone numbers, IM addresses, mailing address, or the like; information about social networking communities the visitor participates in; or the like. The invention is not limited to this information, and other information may also be provided, without departing from the scope of the invention. For example, in one embodiment, the visitor may provide auto-affiliation criteria. In one embodiment, a registered visitor may receive a unique identifier that is useable at content servers 107-109. In one embodiment, the unique identifier may be provided within a cookie. However, the unique identifier may also be provided using any of a variety of other mechanisms. In one embodiment, the unique identifier may be created based on a timestamp, or the like. In one embodiment, the unique identifier may be encrypted.

When a registered visitor visits one of content servers 107-109, the visitor may provide the unique identifier to the visited content server. The visited content server may then provide the unique identifier to AMS 106. AMS 106 may perform a search using the unique identifier. If a match is found, AMS 106 may provide information about the visitor to the visited content server.

Devices that may operate as AMS 106 include personal computers desktop computers, multiprocessor systems, microprocessor-based or programmable consumer electronics, network PCs, servers, and the like.

Although FIG. 1 illustrates AMS 106 as a single computing device, the invention is not so limited. For example, one or more functions of AMS 106 may be distributed across one or more distinct computing devices.

### Illustrative Affiliation Management Environment

FIG. 2 shows one embodiment of a network device, according to one embodiment of the invention. Network device 200 may include many more components than those shown. The components shown, however, are sufficient to disclose an illustrative embodiment for practicing the invention. Network device 200 may represent, for example, AMS 106 of FIG. 1.

Network device 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of network device 200. Any general-purpose operating system may be employed. Basic input/output system (“BIOS”) 218 is also provided for controlling the low-level operation of network device 200. As illustrated in FIG. 2, network device 200 also can communicate with the Internet, or some other communications network, via network interface unit 210, which is constructed for use with various communication protocols including the TCP/IP protocol. Network interface unit 210 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management, web servers, and so forth. Mass memory also includes centralized data store 252. Applications 250 also include Affiliation Manager (AM) 256.

Centralized data store 252 is configured and arranged to receive and manage centralized visitor registrations and/or affiliation information. Centralized data store 252 may include any of a variety of information related with a registered visitor, including, but not limited to an alias, a name, a birth date, a gender, an address, an avatar, or other photograph, an email address, a phone number, various other account addresses including but not limited to IM, ICQ accounts, or the like. Centralized data store 252 may also include information about user names associated with the visitor for various communities, or the like. Centralized data store 252 may further include information about a visitor's preferences. For example, in one embodiment, centralized data store 252 may include a visitor's auto-affiliation criteria. Such auto-affiliation criteria may include any of a variety of criteria. For example, such criteria may include, a request to automatically affiliate a visitor to a community site if the visitor visits that community site a pre-defined number of times, visits or accesses a pre-defined number of webpages within the community site, or the like. In one embodiment, the criteria may include time factors, such as visits to the community site are to be within a pre-defined time window. It should be noted, however, that the invention is not limited to these examples, and virtually any auto-affiliation criteria may be employed, without departing from the scope of the invention.

Centralized data store 252 may also include information indicating which community sites a registered visitor is affiliated. In one embodiment, centralized data store 252 may include information indicating which, if any, community sites, the registered visitor may also author, host, or otherwise manage. Centralized data store 252 may be implemented as a data base, a folder, a script, a program, or the like. Moreover, Centralized data store 252 may also be configured and arranged to reside within hard disk drive 228, cd-rom/dvd-rom drive 226, a removable storage device, or any of a variety of other storage mediums.

AM 256 is configured and arranged to manage centralized registrations for visitors to various community sites such as may be hosted on content servers 107-109 of FIG. 1. AM 256 may receive a request for registration from a visitor of a content server. In one embodiment, the content server may redirect the visitor to AM 256 to perform centralized registration. AM 256 may provide a user interface that may include forms, menus, selectable icons, links, or the like, configured to receive visitor registration information. In one embodiment, the visitor may provide photographs, links, or the like, as part of the registration process. In one embodiment, the visitor may provide auto-affiliation criteria, such as described above. In one embodiment, AM 256 may establish a default auto-affiliation criteria. In one embodiment, the default criteria, may be to not employ auto-affiliation; however, virtually any default criteria may be employed. Moreover, typically, registration does not include affiliating the visitor to a community site. However, the invention is not so constrained, and in one embodiment, the visitor may indicate one or more community sites to be affiliated with during the registration process. The visitor may also indicate any community sites for which the visitor with which the visitor is currently affiliated. In one embodiment, the visitor may also provide information indicating that the visitor hosts, authors, or otherwise manages one or more community sites.

In one embodiment, the visitor need not provide a complete set of registration information, and a minimum set of information might be provided. For example, the visitor might provide as a minimum set, an avatar, a name or alias, and/or an email address, or the like. Moreover, the visitor may also modify information provided during an initial centralized registration, or even at a subsequent time. The visitor may also—un-register from the centralized registration system of AM 256.

When a visitor has initially registered, AM 256 may provide the visitor with a unique identifier, useable for enabling selective display of at least some of the visitor's information, identifying the visitor's affiliations to community sites, or the like. In one embodiment, the unique identifier is a sequence of digits that may include, at least in part, a timestamp. However, the unique identifier is not constrained to including timestamps, and virtually any other data may be employed to generate the unique identifier, including but not limited to at least some of the information provided by the visitor during registration, or a combination of such information. In one embodiment, the unique identifier is encrypted. In one embodiment, the unique identifier may be provided to the visitor in a network cookie. However, the invention is not so limited, and the unique identifier may be provided using any of a variety of other mechanisms.

AM 256 may be further configured to receive the unique identifier from a content server. AM 256 may perform a search within centralized data store 252 for a match on the unique identifier. If a match is found, AM 256 may then provide the content server with the registered visitor's information. In one embodiment, AM 256 may also receive additional information from the content server that may be employed to determine whether the auto-affiliation criteria is satisfied. In one embodiment, AM 256 may provide the auto-affiliation criteria to the content server whereby the content server determines whether the criteria is satisfied. If the auto-affiliation criteria is satisfied, AM 256 (or the content server) may automatically affiliate the visitor to that community site, and provide such information to centralized data store 252. In one embodiment, however, the visitor may also select an icon, or the like, that indicates that the visitor is to be affiliated with or un-affiliated with the community site. AM 256 may then affiliate or un-affiliate, as appropriate, the visitor to the community site, independent of the auto-affiliation criteria.

AM 256 may further be configured to access centralized data store 252 to enable various displays of visitor/member affiliation information. In one embodiment, AM 256 may be configured to display within a member's (a registered visitor's) affiliation page, information about which communities the registered visitor is affiliated, which communities the registered visitor authors, or otherwise manages. AM 256 may also be configured to display within community site page, or provide information to the community site that enables information to be displayed, that indicates which visitors are affiliated with the community site, which affiliates are most current, or the like. In one embodiment, display of such information about affiliations may include at least one visitor that is not centrally registered.

### Generalized Operation

The operation of certain aspects of the invention will now be described with respect to FIGS. 3-5. FIG. 3 illustrates a logical flow diagram generally showing one embodiment of a process for centralized visitor registration for distributed social networking websites, or other community sites. Process 300 of FIG. 3 may, for example, be implemented within AMS 106 of FIG. 1.

Process 300 may begin, after a start block, at decision block 4302 where a determination is made whether a visitor requests to be centrally registered. Such request may be performed by a visitor to a content server site, selecting registration. In one embodiment, a link or the like may be displayed on the content server site that the visitor may select for central registration. In another embodiment, the visitor may select another link that enables the visitor to modify their registration information. Thus, if the visitor is to be registered, processing flows to block 304; otherwise, processing branches to decision block 314.

At block 304, the requestor may be redirected to the centralized registrar, if not already at it, wherein in one embodiment, a webpage, including a form screen may be displayed for use in central registration. The visitor may employ the form, selectable icons, webpage, or the like, to provide selected visitor information, such as described above. In one embodiment, the visitor may identify which content services, websites, communities, or the like, may display at least some of the visitor's information, while another content service, website, or the like, may be identified to not display at least some of the visitor's information. However, the invention is not so limited. For example, the visitor may provide at a later time such information regarding whether a site may or may not display their visitor information.

Processing continues to block 306, where the visitor information may include selection of an auto-affiliation criteria, useable to determine whether to be automatically affiliated as a member of a content service based on a variety of factors, including, but not limited to a number of visits to the content service, and number of webpages viewed within the content service, or the like. In one embodiment, the visitor may select not to be automatically affiliated.

In any event, such visitor information may be received and displayed for the visitor to review. The visitor information may be displayed within a web browser on the visitor's client device.

Processing continues to block 308, where, in one embodiment, a unique centralized identifier may be provided to the visitor. In one embodiment, the unique identifier may be based on a timestamp. In one embodiment, the unique identifier may be a digital value ranging in length from 8-30 bytes. However, the invention is not so constrained, and the unique identifier may also be shorter, or longer, without departing from the scope of the invention.

In one embodiment, the unique identifier may be provided to the visitor over a network using a network cookie. However, the unique identifier may also be provided using any of a variety of other mechanisms. For example, the unique identifier may be provided using a message packet, a get/post mechanism, a JavaScript, applet, or the like, without departing from the scope of the invention.

Processing continues next to decision block 310, where a determination is made whether the visitor selects to modify any of their visitor information. If not, processing continues to block 312; otherwise, processing branches to block 318, where any modifications to the visitor information may be received and displayed for further review by the visitor. It should be noted that the visitor may provide some information, modify other information, and add new information, in almost any sequence, without departing from the scope of the invention. Thus, although process 300 illustrates one sequence of events, the other sequences or out of sequences actions may also be performed. In any event, as illustrated, upon completion of block 318, the process may loop back to decision block 310.

At block 312 the visitor information may then be provided, in one embodiment, to the centralized data store. However, in another embodiment, block 312 may be performed concurrent with receiving visitor information from the visitor. Processing, in any event, may then return to a calling process to perform other actions.

Back at decision block 314, however, a determination is made whether the visitor is currently registered. This may be determined, in one embodiment, based on whether the visitor has provided a valid unique identifier. If the visitor is registered, processing flows to decision block 310. However, if the visitor is not currently registered, processing may return to a calling process to perform other actions. In another embodiment, the visitor may be returned to a display of content from the redirecting content server, or the like.

FIG. 4 illustrates a logical flow diagram generally showing one embodiment of a process for affiliating a registered visitor to a community site. Process 400 of FIG. 4 may be implemented within AMS 106 of FIG. 1. However, the invention is not so limited. For example, in one embodiment, process 400 may also be implemented within one or more of content servers 107-109 of FIG. 1.

Process 400 begins, after a start block, at decision block 402, where a visitor may visit a community site, or other distributing social networking site, or the like. In one embodiment, the visit is to a community site's affiliation webpage. At decision block 402, a determination is made whether the visitor is currently centrally registered. In one embodiment, this may be determined by whether the visitor provides a unique identifier registered within the centralized data store. If not, then process 400 may branch to block 404, where the visitor may be provided an opportunity to become centrally registered. Processing may then loop back to decision block 402.

However, if the visitor is registered, processing flows to decision block 406, where a determination is made whether the visitor is a member (already affiliated with the community site). If yes, processing continues to block 416; otherwise, processing branches to decision block 408.

At decision block 408, a determination is made whether the auto-affiliation criteria associated with the visitor is satisfied. In one embodiment, where the visitor is currently viewing merely a community site's affiliation webpage, then this determination may be deferred until the visitor accesses another webpage associated with the community site. In any event, if the auto-affiliation criteria are satisfied, processing flows to block 412; otherwise, processing branches to decision block 410. It should be noted, that information may be collected based, in part, on actions by the visitor that may subsequently be employed to auto-affiliate the visitor. For example, assume that the auto-affiliation criteria are based on a number of viewed webpages within the community site greater or equal to two. Then, a first webpage viewed would not satisfy the criteria. However, the visitor may then select to view a second webpage within the community site. At that time, the visitor may then become auto-affiliated to the community site. Thus, it should be apparent that auto-affiliation criteria may be monitored and an action may be taken ‘out of the illustrated sequence” of process 400, without departing from the scope of the invention.

At block 412, the visitor may be automatically affiliated as a member of the community site, without additional action taken by the visitor. In one embodiment, such affiliation information may be provided to a centralized data store, where information about the visitor may be stored, and/or updated. Process 400 then flows to block 416.

At decision block 410, a determination is made whether the visitor pro-actively selects to become affiliated with the community site. For example, in one embodiment, the visitor may select an icon, button, enter a value into a form, radio button, or the like, indicating that the visitor is to be affiliated as a member with the community site. If the visitor so selects, processing flows to block 414, where the visitor is affiliated as a member of the community site. Process 400 then flows to block 416. Otherwise, if the visitor does not select, processing continues to decision block 424.

At block 416, affiliation information for the community site is displayed. One embodiment of a possible screen display of affiliation information for the community site is described in more detail below in conjunction with FIG. 7.

Processing continues to decision block 41 8, where a determination is made whether the affiliated visitor selects to become unaffiliated with the community site. In one embodiment, the visitor may so select by ending data into a data field, clicking a radio button, icon, or the like. In any event, if the visitor so selects, processing may continue to block 420; otherwise, processing branches to decision block 424.

At block 420, the visitor is un-affiliated as a member of the community site. In one embodiment, such information may be provided to the centralized data store. Processing continues next to block 422, where the visitor's information may be removed from the affiliation information within the display of affiliation information for the community site. In one embodiment, a refresh of the screen may be performed automatically to illustrate to the visitor that they had been un-affiliated with the community site. Process 400 then flows to decision block 424.

At decision block 424, a determination is made whether the visitor selects to leave the community site (and/or displayed affiliation page associated with the community site). If so, processing then returns to the calling process to perform other actions. Otherwise, processing loops back to decision block 406.

FIG. 5 illustrates a logical flow diagram generally showing one embodiment of a process for displaying a member's affiliations to various community sites. In one embodiment, process 500 of FIG. 5 may be implemented within AMS 106 of FIG. 1.

Process 500 may begin, after a start block, at block 502, where a visitor may select to visit a member's affiliation site. In one embodiment, such member affiliation sites may be configured and arranged to for each centrally registered visitor. One example of such a member's affiliation site is described in more detail below in conjunction with FIG. 6.

Processing flows to block 504 where community sites that the member (registered visitor) may author, host, or otherwise manage may be displayed. Processing flows next to block 506 where those community sites for which the member is affiliated may also be displayed. In one embodiment, the display of the managed community sites and the affiliated sites may be displayed within a scrollable screen display. However, the invention is not so limited, and other display mechanisms may also be employed.

In any event, processing continues to decision block 508, where the visitor may select to access (or visit) one of the displayed community sites. If so, the visitor is redirected to the selected community site. Such redirection might be to a particular page for the community site, such as the community's affiliation page, a ‘home’ page, or the like. Thus, if the visitor is redirected, process 500 returns to a calling process to perform other actions. However, if the visitor doesn't select a community site, or other selectable item within the display that may result in redirection to another webpage, website, or the like, processing flows to decision block 510. At decision block 510, a determination is made whether the visitor selects to exit the community's affiliation page using any of a variety of other mechanism, including, but not limited to entering another web link, address, or the like, into their web browser, employing a return key, or the like. If the visitor does exit, processing then returns to the calling process; otherwise, processing may loop back to block 504.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

Illustrative Screen Shots of Affiliations with Communities

Various embodiments of certain possible displays of affiliation information will now be described with respect to FIGS. 6-7. FIG. 6 illustrates one embodiment of an example display of a member's affiliation webpage. Display 600 may include many more components than those shown. The components shown, however, are sufficient to disclose an illustrative embodiment for practicing the invention. Display 600 of FIG. 6 may be used in conjunction with process 500 of FIG. 5.

As shown, display 600 may include a member's avatar 602, photograph, image, or the like, along with member information 604. Such member information 604 may include a member's name, alias, hook, or the like; how long the member has been centrally registered; when the member last logged into at least one of the distributed community sites; or the like. Clearly, the amount, type, or format, of member information 604 is not constrained to that which is illustrated within display 600, and other formats, and/or type of member information may be displayed in addition to, and/or in place of at least some of that which is currently displayed within display 600.

Display 600 may also display zero or more authored website icons 606 that may represent those websites, that the member may author, host, or otherwise manage. Display 600 may also include affiliated website icons 608 representing community sites for which the member is currently affiliated as a member. The invention is not constrained to illustrating the website icons in rows as shown and other formats and/or layouts may also be employed. For example, authored website icons 606 and/or affiliated website icons 608 may be illustrated side by side, within separately scrollable frames, or the like, without departing from the scope of the invention.

A visitor displaying display 600 within their web browser, or the like, may select (click on) an affiliated website icon 608, or an authored website icon 606, and be redirected to a webpage associated with the community site associated with the website icon.

Also shown, is one possible mechanism 610 for accessing additional information. For example mechanism 610 is illustrated as representing a link (URI or the like) that may be selected to display additional community sites (affiliated website icons 608) for which the member is affiliated. The invention, however, is not limited to employing such mechanism, however. For example, all such website icons may be displayed within a scrollable window, frame, or the like.

FIG. 7 illustrates one embodiment of an example display of a community's affiliation webpage, in accordance with the present invention. Display 700 may include many more or less components than those shown. The components shown, however, are sufficient to disclose an illustrative embodiment for practicing the invention. Display 700 of FIG. 7 may be used in conjunction with process 400 of FIG. 4.

As illustrated, display 700 includes a website icon 702 associated with the community site, community information 704, and author information 706. In one embodiment, community information 704 may include a community site name, and/or a link, to a particular webpage within the community site, such as a home page, or the like. Website icon 702 may also be configured such that a visitor may click on it to be redirected to a particular webpage within the community site. Author information 706 may include, but is not limited to an avatar, photograph, name, alias information, or the like.

Display 700 may also include newest member icons 708 and current member icons 710. In one embodiment, newest member icons 708 may be a subset of current member icons 710. Newest member icons 708 and current member icons 710 may represent clickable icons that may redirect a visitor to a member's affiliation page, or the like. A criterion useable to determine which member icons are displayed within newest member icons 708 may include, but not be limited to, those visitors that became affiliated to the community site within a pre-defined time period, or even a pre-defined number of the visitors that became affiliated within the pre-defined time period, or the like. In one embodiment, if the visitor's member icon is displayed within display 700, the visitor may select to become un-affiliated with the community site, in one embodiment, by” mousing over” their member icon and selecting to become un-affiliated. In one embodiment, such mousing over, may also enable the member of manage whether their member information is displayed without becoming unaffiliated.

Also illustrated in display 700 is affiliation icon 714 that may be configured and arranged to enable a visitor to display 700 pro-actively select to become affiliated with the associated community site. In one embodiment, if the visitor is currently a member of the community site, affiliation icon 714 may be configured and arranged to enable the visitor to become un-affiliated. Thus, in one embodiment, based on a status of the visitor, affiliation icon 714 may change its operation and/or how it is displayed.

As shown, display 700 further includes one possible mechanism 712 for accessing additional information. For example mechanism 6712 is illustrated as representing a link (URI or the like) that may be selected to display additional member information for members affiliated to the community site. The invention, however, is not limited to employing such mechanism, however. For example, all such affiliation icons may be displayed within a scrollable window, frame, or the like. Moreover, display of the newest member icons 708 and current member icons 710 may be achieved using separate frames, side by side formats, or any of a variety of other structures, without departing from the scope of the invention.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A system for managing network activities, comprising:
an affiliation management computing device that is arranged and configured to perform actions, including:
receiving a request from a user to be centrally registered for plurality of social networking communities;
displaying a user affiliation webpage that displays at least an avatar associated with the user; and
a social networking community's computing device that is arranged and configured to perform actions, including:
enabling the user to access a webpage managed by the social networking community's computing device;
affiliating the user as a member of the social networking community based, in part, on the access to the webpage;
displaying another webpage that displays avatars associated with members affiliated with the social networking community including the user's avatar; and
providing affiliation information to the affiliation management computing device to enable the user's affiliation webpage to be updated to display the user's affiliation to the social networking community.

2. The system of claim 1, wherein affiliating the user as a member further comprises:
automatically affiliating the user as a member based on a pre-defined action by the user with the social networking community.

3. The system of claim 1, wherein receiving a request from the user further comprises:
receiving from the user an auto-affiliation criteria that enables the user to become automatically affiliated to at least one of the plurality of social networking communities when the criteria is satisfied.

4. The system of claim 1, wherein the affiliation management computing device that is arranged and configured to perform actions, further including:
providing a unique identifier to the registered user, wherein the unique identifier is employable the at least one of the social networking community's computing device in tracking actions by or displaying information about the user.

5. The system of claim 1, wherein receiving a request from the user further comprises:
receiving information from the user associated with at least one social networking community for which the user is currently affiliated.

6. The system of claim 1, wherein the user's affiliation webpage further comprises at least one of information associated with a social networking community for which the user is an author or manages, or information associated with any social networking communities in the plurality for which the user is currently affiliated.

7. A processor readable medium that includes instructions, wherein the execution of the instructions provides for managing social networking user information by enabling actions, including:
receiving information about a user;
displaying at a client computing device a user affiliation webpage that includes at least some of the information about the user, including at least one of a community site for which the user is an author or manages, or a community site for which the user is affiliated;
receiving affiliation information for the user from at least one community site; and
displaying at the client computing device within an affiliation webpage for the community site, at least some of the information about the user along with information associated with at least one other user affiliated with the community site.

8. The processor readable medium of claim 7, wherein receiving information about the user further comprises receiving at least one of a name, an alias, an email address, or an avatar associated with the user.

9. The processor readable medium of claim 7, wherein receiving affiliation information for the user from at least one community site further comprise:
receiving affiliation information, wherein the user is automatically affiliated with the at least one community site based on a pre-defined auto-affiliation criteria.

10. The processor readable medium of claim 7, wherein enabling actions, further comprising:
receiving additional information about the user indicating that the user is un-affiliated with a community site with which the user was previously affiliated; and
updating the user affiliation webpage and the community site affiliation webpage; and
displaying at least one of the updated user affiliation webpage or the updated community site affiliation webpage.

11. A network device to manage user information over a network, comprising:
a transceiver to send and receive data over the network; and
a processor that is operative to perform actions, including:
receiving a request from a user to be centrally registered for plurality of distributed community sites;
receiving information about the user;
displaying at a client computing device a user affiliation webpage that includes at least some of the information about the user, including at least one of a community site for which the user is an author or manages, or a community site for which the user is affiliated;
receiving affiliation information for the user from at least one community site; and
displaying at the client computing device within an affiliation webpage for the community site, at least some of the information about the user along with information associated with at least one other user affiliated with the community site.

12. The network device of claim 11, wherein receiving information about the user further comprises receiving an auto-affiliation criteria for automatically affiliating the user to a community site.

13. The network device of claim 11, wherein receiving affiliation information for the user from at least one community site further comprises:
receiving information about an action taken by the user while visiting the at least one community site; and
if the action satisfies an auto-affiliation criteria for the user, automatically affiliating the user to the at least one community site.

14. A network device that is operative to enable managing of a community site, comprising:
a memory component for storing instructions; and
a processing component for executing instructions that enables actions, including:
receiving a request from a user to access at least one webpage;
receiving information about the user;
employing the received information and at least one action taken by the user while accessing the at least one webpage, to determine if the user satisfies an auto-affiliation criteria; and
if the user action satisfies the auto-affiliation criteria, automatically affiliating the user to the community site; and
updating for display at another network device, at least one or a user affiliation webpage or a community site affiliation webpage to indicate whether the user is affiliated with the community site.

15. The network device of claim 14, wherein receiving information about the user further comprises receiving at least one of a unique identifier, a name, an alias, an email address, or an avatar.

16. The network device of claim 14, wherein the auto-affiliation criteria further comprises at least one of a number of webpages viewed by the user within the community site or a number of times the user has visited the community site.

17. A method of managing network activity over a network, comprising:
receiving a request from a user to be centrally registered for plurality of distributed community sites;
receiving information about the user;
displaying at a client computing device a user affiliation webpage that includes at least some of the information about the user, including at least one of a community site for which the user is an author or manages, or a community site for which the user is affiliated;
receiving affiliation information for the user from at least one community site; and
displaying at the client computing device within an affiliation webpage for the community site, at least some of the information about the user along with information associated with at least one other user affiliated with the community site.

18. The method of claim 17, wherein receiving affiliation information for the user further comprises receiving information useable to determine if the user has performed an action that satisfies an auto-affiliation criteria for the at least one community site.

19. The method of claim 17, wherein displaying the at least one community site further comprises displaying a clickable icon for the at least one community site, wherein clicking on the icon redirects the user to a webpage associated with the community site.

20. A modulated data signal configured to include program instructions for performing the method of claim 17.
